(19) United States
(12) Patent Application Publication
(10) Pub. No.: US 2004/0042041 A1
(43) Pub. Date: Mar. 4, 2004

(54) Image forming device

(75) Inventor: Jin-su Yun, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/648,249

(22) Filed: Aug. 27, 2003

(30) Foreign Application Priority Data
Aug. 27, 2002 (KR) 2002-50950

(51) Int. Cl. G06F 13/00; G06F 13/10; G06F 9/44; G06F 9/445

(52) U.S. Cl. 358/1.15; 719/327; 358/1.16; 717/168

(57) ABSTRACT

An image forming device and method include a first storage storing a first function program, a system memory, a second storage storing a second function program, and a controller. When power or a reset signal is applied to the image forming device, the controller executes the first function program and executes the second function program after downloading the second function program to the system memory.

### CROSS-REFERENCE TO RELATED APPLICATIONS

This application claims the benefit of Korean Application No. 2002-50950, filed Aug. 27, 2002, in the Korean Intellectual Property Office, the disclosure of which is incorporated herein by reference.

### BACKGROUND OF THE INVENTION

1. Field of the Invention

The present invention relates to an image forming device, and more particularly, to an image forming device which is provided with separate storing spaces for storing a program to initialize the image forming device and an operating program for operating a system of the image forming device, thereby enabling an easy management of the programs.

2. Description of the Related Art

Image forming devices such as facsimile machines, printers and multifunction machines includes functions to print, fax, and/or copy. The printers are frequently used for visualizing computer-processed information.

FIG. 1 is a schematic view showing a conventional image forming device. Referring to FIG. 1, the image forming device includes a video controller 10 and a printing engine unit 30. The video controller 10 processes printing data transmitted from an external device (for example, a host computer) in order for the printing engine unit 30 to print the printing data.

The video controller 10 includes an interface portion 12 receiving the printing data by interfacing with the external device, a storage 14 storing programs such as a boot program, an operating program, and an application program. The video controller 10 further includes a system memory 16 storing a program necessary to operate a system and data generated following the execution of the program, and a controller 18 controlling the interface portion 12, the storage 14, and the system memory 16.

The printing engine unit 30 performs a printing operation with respect to the printing data transmitted from the video controller 10 according to a control of the controller 18.

By the supply of power, the image forming device is initialized through a system reset. When the image forming device is initialized, the controller 18 executes the boot program stored in the storage 14. The operating program stored in the storage 14 is executed as the boot program is executed, thereby initializing the system.

Such processes of executing the operating program through a series of initialization processes are called “booting”.

In the conventional image forming device, however, because the boot program and the operating program are stored in the same storage, modularization thereof is difficult and, thus, upgrading the programs is impossible. Accordingly, reprogramming and version management are not easy.

### SUMMARY OF THE INVENTION

According to an aspect of the present invention there is provided an image forming device that enables easy upgrade and modularization of programs by storing a boot program and a system program to operate a system in separate storing spaces.

Additional aspects and/or advantages of the invention will be set forth in part in the description which follows and, in part, will be obvious from the description, or may be learned by practice of the invention.

According to an aspect of the present invention, there is provided an image forming device including: a system memory storing data for a system operation; a memory controller controlling the system memory; a printing engine unit performing a printing operation to print data; a controller; a system bus having an address bus and a data bus; a first storage storing a first function program to perform a booting and initialization of the image forming device; and a second storage storing a second function program to perform a system operation and a specific function, wherein the first storage and the second storage are connected to the controller via the data bus, and at least one of the first storage and the second storage is connected to the controller via the address bus.

In accordance with an aspect of the present invention, the controller executes the first function program stored in the first storage when power is applied to the image forming device, and executes the second function program with the executed first function program to initialize the image forming device.

The second function program stored in the second storage is downloaded to the system memory.

In accordance with an aspect of the present invention, there is provided an image forming device and method including a first storage storing a first function program, a system memory, a second storage storing a second function program, and a controller. When power or a reset signal is applied to the image forming device, the controller executes the first function program and executes the second function program after downloading the second function program to the system memory.

In accordance with an aspect of the present invention, there is provided a method of an image forming device including a first storage, a second storage, a memory controller, a system controller, a controller, and an interface portion, the method including: applying power or a reset signal to initialize the image forming device; executing a boot program stored in the first storage; downloading a system operating program stored in the second storage to the system memory; and executing the operating program stored in the system memory when the downloading is complete.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a conventional image forming device;

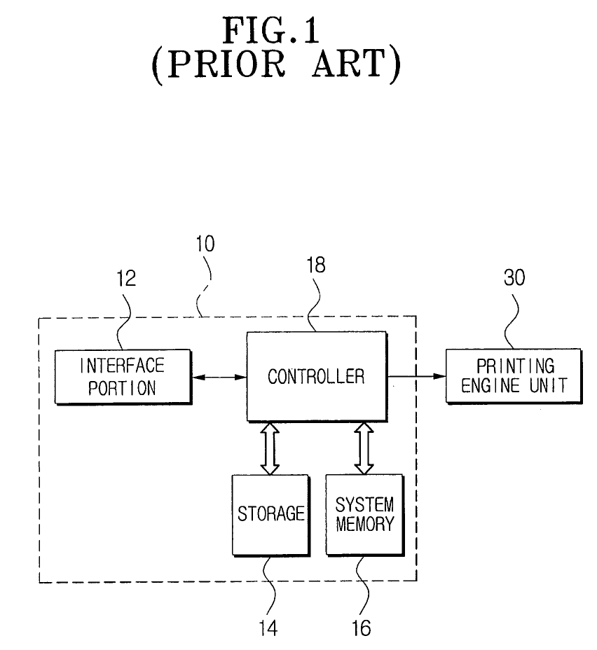

FIG. 2 is a block diagram showing an image forming device, according to an aspect of the present invention; and

FIG. 3 is a flowchart showing a process of initializing a system of the image forming device of FIG. 2.

### DETAILED DESCRIPTION OF THE INVENTION

Reference will now be made in detail to the aspects of the present invention, examples of which are illustrated in the accompanying drawings, wherein like reference numerals refer to like elements throughout. The embodiments are described below in order to explain the present invention by referring to the figures.

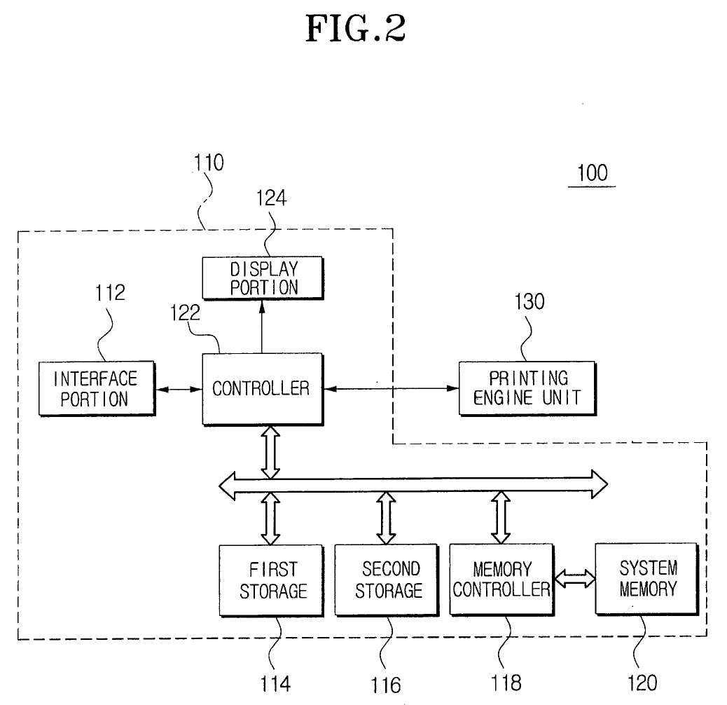

FIG. 2 is a block diagram showing an image forming device, according to an aspect of the present invention.

Referring to FIG. 2, an image forming device 100 has a video controller 110 and a printing engine unit 130.

The video controller 110 converts printing data transmitted from a host computer (not shown) into image data and then outputs the image data to the printing engine unit 130.

The video controller 110 has an interface portion 112, a first storage 114, a second storage 116, a memory controller 118, a system memory 120, a controller 122, and a display portion 124.

The interface portion 112 is connected with the host computer to support a mutual data communication between the controller 122 and the host computer. The interface portion 112 serves as a module to interface in parallel or serially between the host computer and the controller 122 and receives the printing data from the host computer. Also, the interface portion 112 provides the host computer with information about a power supply of the image forming device 100 and printing information.

The first storage 114 stores a first function program such as a boot program that boots the image forming device 100. The first storage 114 uses a ROM, a flash memory, or other types of memory.

The second storage 116 stores a second function program such as a system operating program and an application program. The second storage 116 uses a ROM, a flash memory or other types of memory.

The system memory 120 is a storing space that serves as a buffer, to process data generated during an operation of the image forming device 100 operated in accordance with an execution of the system operating program and the application program. The system memory 120 uses a volatile memory element such as a DRAM or a SRAM.

The first storage 114, the second storage 116, the memory controller 118, and the system memory 120 are connected to the controller 122 via a system bus including an address/data bus and a control bus. The address/data bus is for transmitting data information and addresses.

Depending on a memory type being employed, the second storage 116 storing the system operating program can be connected to the controller 122 via the address/data bus or the data bus alone. For example, an HDD or a NAND type flash memory permits data to be input/output via the data bus alone.

The memory controller 118 downloads the system operating program stored in the second storage 116 to the system memory 120 according to a control from the controller 122.

The controller 122 communicates with the host computer via the interface portion 112, and converts the printing data received via the interface portion 112 to data to be processed by the printing engine unit 130 and transmits the data to the printing engine unit 130.

Also, when power is applied to the image forming device 100, the controller 122 executes the boot program stored in the first storage 114. With the boot program being executed, the controller 122 executes the system operating program stored in the second storage 116 to initialize the system.

Also, the controller 122 controls the memory controller 118 to download the system operating program stored in the second storage 116 to the system memory 120. The system operating program and other application programs are executed after being downloaded to the system memory 120 that employs the SRAM or the DRAM characterized in a high speed access to the memory, thereby improving a processing speed of the image forming device 100.

The controller 122 has an option of executing any one of the programs stored in the second storage 116 and any one of the programs downloaded to the system memory 120. The display portion 124 displays a general operating status of the image forming device 100 according to a control of the controller 122. The printing engine unit 130 receives the image data processed by the video controller 110 and performs a printing operation with respect to the image data.

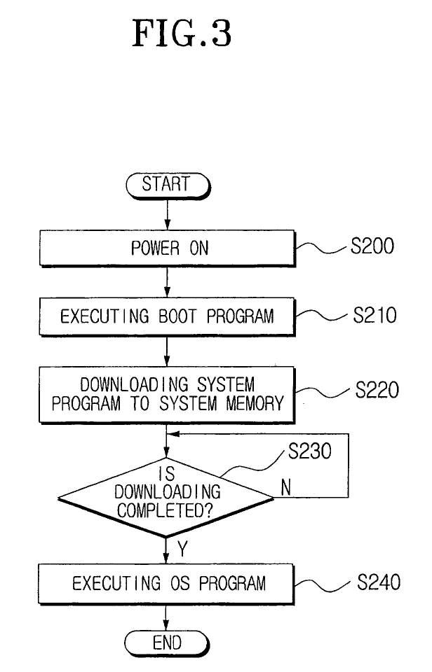

Hereinafter, a process of initializing the system of the image forming device, according to an aspect of the present invention, will be described with reference to FIG. 3.

At S200, if power or a reset signal is applied to the image forming device 100, at S210, the controller 122 executes the boot program stored in the first storage 114. With the boot program being executed, at S220, the controller 122 controls the memory controller 118 to download the system operating program stored in the second storage 116 to the system memory 120.

At S230, the controller 122 determines whether downloading of the system operating program to the system memory 120 is completed or not. At S240, if it is determined that the downloading is completed, the controller 122 executes the operating program stored in the system memory 120. When the image forming device 100 is applied with the power, the controller 122 initializes the system of the image forming device 100 by performing S210 to S240.

As described above, the boot program, the operating program, and the application program are stored in separate storing spaces such that a selective upgrade of the programs becomes possible.

According to the image forming device as described above, because it is provided with separate storing media to respectively store the boot program and the system operating program, modularization of the programs becomes possible. Accordingly, an upgrade and version management of the programs become easier.

Also, by using an inexpensive memory to store the system operating program or a storing media permitting input/output data simply via a data bus, the cost of a product including the image forming device, according to an aspect of the present invention, can be reduced. Also, because the system operating program and the application program are downloaded and executed on the system memory at a high processing speed, the processing speed of the image forming device can be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming device, comprising:
a system memory storing data for a system operation;
a memory controller controlling the system memory;
a printing engine unit performing a printing operation to print data;
a controller;
a system bus having an address bus and a data bus;
a first storage storing a first function program to perform a booting and initialization of the image forming device; and
a second storage storing a second function program to perform a system operation and a specific function, wherein
the first storage and the second storage are connected to the controller via the data bus, and at least one of the first storage and the second storage is connected to the controller via the address bus.

2. The image forming device of claim 2, wherein the controller executes the first function program stored in the first storage when power is applied to the image forming device, and executes the second function program with the executed first function program to initialize the image forming device.

3. The image forming device of claim 1, wherein the second function program stored in the second storage is downloaded to the system memory.

4. The image forming device of claim 1, wherein the controller controls the first storage, the second storage, the memory controller, and the system memory.

5. An image forming device, comprising:
a first storage storing a first function program;
a system memory;
a second storage storing a second function program; and
a controller, wherein, when power or a reset signal is applied to the image forming device, the controller executes the first function program and executes the second function program after downloading the second function program to the system memory.

6. The image forming device of claim 5, wherein the controller selectively executes the second function program stored in the second storage and at least one program downloaded to the system memory.

7. The image forming device of claim 5, wherein the first function program comprises a boot program.

8. The image forming device of claim 7, wherein the second function program comprises a system operating program and an application program.

9. The image forming device of claim 8, wherein the system memory is a buffer to process data generated during an operation of the image forming device in accordance with an execution of the system operating program and the application program.

10. The image forming device of claim 8, further comprising:
a memory controller downloading the system operating program stored in the second storage to the system memory according to a control from the controller.

11. The image forming device of claim 5, further comprising:
a system bus comprises an address/data bus and a control bus to connect the first storage, the second storage, the memory controller, and the system memory.

12. The image forming device of claim 5, further comprising:
a display portion displaying a general operating status of the image forming device according to a control of the controller.

13. The image forming device of claim 5, further comprising:
an interface portion supporting communication between the image forming device and a host computer, wherein the controller converts printing data from the host computer via the interface portion to data to be processed by a printing engine unit.

14. The image forming device of claim 8, wherein the boot program is stored in the first storage and the operating program and the application program are stored in the second storage allowing a selective upgrade and management of the programs.

15. A method of an image forming device comprising a first storage, a second storage, a memory controller, a system memory, a controller, and an interface portion, the method comprising:
applying power or a reset signal to initialize the image forming device;
executing a boot program stored in the first storage;
downloading a system operating program stored in the second storage to the system memory; and
executing the operating program stored in the system memory when the downloading is complete.
